(19) United States
(12) Patent Application Publication
(10) Pub. No.: US 2010/0162693 A1
(43) Pub. Date: Jul. 1, 2010

(54) METHOD OF REDUCING TORQUE RIPPLE IN HYDRAULIC MOTORS

(76) Inventors: Paul W. Michael, Milwaukee, WI (US); Steven N. Herzog, Glen Mills, PA (US)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/347,608

(22) Filed: Dec. 31, 2008

(51) Int. Cl. F16H 39/00

(52) U.S. Cl. 60/327

(57) ABSTRACT

Torque Ripple is reduced in hydraulic system by operating with a hydraulic fluid having a VI of at least 130.

### BACKGROUND OF THE INVENTION

1. Field of the Invention

The present invention relates to the reduction of torque ripple in hydraulic motors, achieved by the use of hydraulic fluids with high VI (viscosity index). Use of such fluids can increase the power output of the system without any modification of the hardware.

2. Description of the Related Art

Hydraulic systems are designed to transmit energy and are capable of applying large forces with a high degree of power control and flexibility of direction. It is desirable to build systems that efficiently convert input energy from an engine, electric motor, or other energy source into usable work. Hydraulic power can be used to create rotary or linear motion, and can be stored for future use in an accumulator. Hydraulic systems provide greater power densities than electrical or mechanical systems. In general, hydraulic systems are reliable, efficient, and cost effective, leading to their widespread use. The fluid power industry is constantly looking for new ways of improving the cost effectiveness and productivity of hydraulic systems by employing new mechanical components and materials of construction, therefore, the possibility of enhancing efficiency by changing the characteristics of the hydraulic fluid is a useful addition.

Water and many other liquids can be utilized as hydraulic fluids. Standard “HM” (monograde) oil is typically selected as a low cost option and has a long history of dependable performance, although performance may suffer if the external temperature changes significantly. Outdoor applications of fluid power that experience wide variations in temperature will typically benefit from the use of lower viscosity grade fluids in the winter and higher viscosity grade fluids in the summer. As an alternative to changing fluids for optimum viscosity, some hydraulic fluids are formulated with PAMA additives as viscosity index improvers in order to achieve good low temperature fluidity properties; cold start-up (“HV” grade oils) is a good example. The usage of PAMA can also affect performance at elevated temperatures.

WO 2005108531 describes the use of hydraulic fluids comprising PAMA additives in order to reduce the temperature increase of a hydraulic fluid under work load. A reduction in torque ripple, however, is not indicated or suggested by that document.

WO 2005014762 discloses a functional fluid having an improved fire resistance. The fluid can be used in hydraulic systems. However, the document is silent with regard to a reduction in torque ripple using such a fluid.

Achieving higher power output in a hydraulic system is typically achieved by selecting a larger pump, or by other hardware construction improvements of the unit providing mechanical energy to the hydraulic system. Such an approach, however, is usually accompanied by higher energy consumption and increased cost.

Thus, techniques of improving power output and efficiency in hydraulic motors and pumps are still being sought.

### SUMMARY OF THE INVENTION

It is an object of the present invention to improve hydraulic systems by increasing power output and increasing productivity due to a reduction of torque ripple. Increased power output can be used to generate increased digging force, increased lifting capacity, or increased machine speed any of which contribute to improved efficiency.

These and other objectives have been achieved by the present invention, a method of reducing torque ripple in a hydraulic system. This enhanced system comprises operating a hydraulic system with a hydraulic fluid having a VI of at least 130.

### BRIEF DESCRIPTION OF DRAWINGS

FIG. 1 depicts Comparison of mechanical efficiency of Geroler motor at 1 RPM and 80° C. with ISO 46 HM and ISO 46HVI fluids.

FIG. 2 depicts Comparison of mechanical efficiency of axial piston motor at 1 RPM and 80° C. with ISO 46 HM and ISO 46HVI fluids.

FIG. 3 depicts Flow and torque ripple in a geroler motor, 15 second interval and 1 RPM.

FIG. 4 depicts Flow and torque ripple in an axial piston motor at 15 second interval and 1 RPM.

FIG. 5 depicts Reduction in torque ripple of geroler at 1 RPM and 80° C.

FIG. 6 depicts Reduction in torque ripple of axial piston motor at 1 RPM and 80° C.

### DETAILED DESCRIPTION OF THE INVENTION

The reduction in torque ripple in a hydraulic motor is achieved by the use of a fluid according to the present invention; the use of a fluid having a VI of at least 130.

The HM hydraulic fluid (monograde) of the present invention exhibits good resistance to oxidation and is chemically very stable, compared to a standard HM fluid. In the context of the present invention, “HM” is a designation for monograde hydraulic fluid based on mineral oil, containing rust and oxidation inhibitors with anti-wear characteristics. “HV” is a designation for an HM fluid with improved viscosity/temperature properties, intended for operation over a wide range of ambient temperatures. Both designations are defined by the ASTM D 6158 specification

The hydraulic fluid used according to the present invention can have a viscosity at 40° C. within a broad range, typically 15 mm²/s to 150 mm²/s.

The hydraulic fluid used according to the present invention has a viscosity index of at least 130, preferably at least 150, more preferably at least 180 and most preferably at least 200. The viscosity index (VI) can be determined according to ASTM D 2270. Viscosity index (VI) as defined by ASTM D2270 is the relationship between the kinematic viscosity at 40° C. and the kinematic viscosity at 100° C.

The use according to the present invention provides a reduction in torque ripple in a hydraulic system. The expression “power output” means energy usable as work, typically measured and quantified as output torque from a rotary hydraulic motor in horsepower or kilowatts.

Preferably, the fluid of the present invention is effective in reducing torque ripple in a hydraulic system by at least 2%, more preferably at least 3% and more preferably at least 10%, compared to the torque ripple of a system using a monograde hydraulic fluid having a VI of about 100 operating at the same pressure and temperature with identical mechanical power input from the engine or electric motor. Although equal amounts of energy are consumed (fuel or electricity) for both fluids, the system using the high VI fluid will produce less torque ripple and have higher and more consistent power output.

The improvements mentioned above can be used to increase the performance of a hydraulic system in an astonishing manner. By providing a system with reduced torque ripple, the hydraulic system can use more of the power produced by the unit creating mechanical energy. Therefore, a defined amount of work can be done in a shorter time without the need of constructional changes of the system. Ideally, for example the engine speed of the unit providing mechanical energy (e.g. diesel engine driving a hydraulic pump) is maintained at a constant rate and the hydraulic system delivers an increased level of power.

The hydraulic fluid according to the present invention may be obtained by mixing a base fluid and a polymeric viscosity index improver. The hydraulic fluid comprises at least 60% by weight of at least one base fluid. Preferably, the hydraulic fluid comprises at least 60% by weight of at least one base fluid having a viscosity index of 120 or less. Further, the hydraulic fluid may comprise a member selected from the group consisting of a mineral oil, synthetic oil and mixtures thereof.

The hydraulic fluid may comprise an API group I oil, API group II oil, API group III oil, a API group IV oil, API group V oil, a Fischer-Tropsch (GTL) derived oil or mixtures thereof. In addition, the hydraulic fluid may comprises a polyalphaolefin, a carboxylic ester, a vegetable ester, a phosphate ester, a polyalkylene glycol or mixtures thereof.

In another embodiment, the hydraulic fluid may comprise at least one polymer. The polymer comprises polymerized units from monomers selected from the group consisting of acrylate monomers, methacrylate monomers, fumarate monomers, maleate monomers and mixtures thereof. Preferably, the hydraulic fluid comprises a polyalkylmethacrylate polymer.

In a preferred embodiment, the polymer is obtained by polymerizing a mixture of olefinically unsaturated monomers, which comprises

a) 0-100 wt % of one or more ethylenically unsaturated ester compounds of formula (I) based on the total weight of the ethylenically unsaturated monomers:

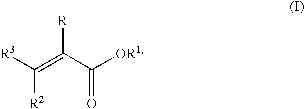

wherein

R is hydrogen or methyl,

R¹ is a linear or branched alkyl residue with 1-6 carbon atoms,

R² and R³ each independently represent hydrogen or a group of the formula —COOR′, wherein R′ is hydrogen or an alkyl group with 1-6 carbon atoms,

b) 0-100 wt % of one or more ethylenically unsaturated ester compounds of formula (II) based on the total weight of the ethylenically unsaturated monomers:

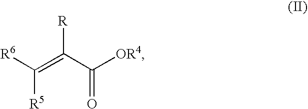

wherein

R is hydrogen or methyl,

R⁴ is a linear or branched alkyl residue with 7-40 carbon atoms,

R⁵ and R⁶ independently are hydrogen or a group of the formula —COOR″, wherein R″ is hydrogen or an alkyl group with 7-40 carbon atoms,

c) 0-50 wt % of comonomers based on the total weight of the ethylenically unsaturated monomers.

Exemplary polymeric viscosity improvers are VISCOPLEX® 8-219 and VISCOPLEX® 1-333, registered trademarks of Evonik RohMax Additives GmbH.

The polymer may be obtained by a polymerization in an API group I oil, API group II oil, API group III oil, a API group IV oil, API group V oil, a Fischer-Tropsch (GTL) derived oil or mixtures thereof. In addition, the polymer may be obtained by a polymerization in a polyalphaolefin, a carboxylic ester, a vegetable ester, a phosphate ester, a polyalkylene glycol or mixtures thereof. In another embodiment, the polymer may be obtained by polymerizing a dispersant monomer.

Preferably, the polymer has a weight average molecular weight in the range of 10000 to 200000 g/mol.

The hydraulic fluid may comprises 0.5 to 40% by weight of a polymer, preferably, 3 to 30% by weight of a polymer.

The hydraulic fluid may be used at a temperature in the range of −40° C. to 150° C.

Preferably, the hydraulic fluid comprises a member selected from the group consisting of antioxidants, antiwear agents, corrosion inhibitors, defoamers and mixtures thereof.

The viscosity of the hydraulic fluid of the present invention can be adapted with in wide range, according to the requirements of the hydraulic pump/motor manufacturer. ISO VG 15, 22, 32, 46, 68, 100, 150 fluid grades can be achieved, e.g.

| ISO 3448 | | | Maximum |
|---|---|---|---|
| Viscosity | Typical Viscosity, | Minimum Viscosity, | Viscosity, cSt @ |
| Grades | cSt @ 40° C. | cSt @ 40° C. | 40° C. |
| ISO VG 15 | 15.0 | 13.5 | 16.5 |
| ISO VG 22 | 22.0 | 19.8 | 24.2 |
| ISO VG 32 | 32.0 | 28.8 | 35.2 |
| ISO VG 46 | 46.0 | 41.4 | 50.6 |
| ISO VG 68 | 68.0 | 61.2 | 74.8 |
| ISO VG 100 | 100.0 | 90.0 | 110.0 |
| ISO VG 150 | 150.0 | 135.0 | 165.0 |

Preferably the kinematic viscosity at 40° C. according to ASTM D 445 of is the range of 15 mm²/s to 150 mm²/s, preferably 28 mm²/s to 110 mm²/s. The kinematic viscosity at 40° C. includes all values and subvalues therebetween, especially including 20, 30, 40, 50, 60, 70, 80, 90, 100, 110, 120, 130 and 140 mm²/s.

For the use according to the present invention, preferred hydraulic fluids are NFPA (National Fluid Power Association) multigrade fluids, e.g. double, triple, quadra and/or penta grade fluids as defined by NFPA T2.13.13-2002.

Preferred fluids comprise at least a mineral oil and/or a synthetic oil.

Mineral oils are substantially known and commercially available. They are in general obtained from petroleum or crude oil by distillation and/or refining and optionally additional purification and processing methods, especially the higher-boiling fractions of crude oil or petroleum fall under the concept of mineral oil. In general, the boiling point of the mineral oil is higher than 200° C., preferably higher than 300° C., at 5000 Pa. Preparation by low temperature distillation of shale oil, coking of hard coal, distillation of lignite under exclusion of air as well as hydrogenation of hard coal or lignite is likewise possible. To a small extent mineral oils are also produced from raw materials of plant origin (for example jojoba, rapeseed (canola), sunflower, and soybean oil) or animal origin (for example tallow or neat foot oil). Accordingly, mineral oils exhibit different amounts of aromatic, cyclic, branched and linear hydrocarbons, in each case according to origin.

In general, one distinguishes paraffin-base, naphthenic and aromatic fractions in crude oil or mineral oil, where the term paraffin-base fraction stands for longer-chain or highly branched isoalkanes and naphthenic fraction stands for cycloalkanes. Moreover, mineral oils, in each case according to origin and processing, exhibit different fractions of n-alkanes, isoalkanes with a low degree of branching, so called monomethyl-branched paraffins, and compounds with heteroatoms, especially O, N and/or S, to which polar properties are attributed. However, attribution is difficult, since individual alkane molecules can have both long-chain branched and cycloalkane residues and aromatic components. For purposes of this present invention, classification can be done in accordance with DIN 51 378. Polar components can also be determined in accordance with ASTM D 2007.

The fraction of n-alkanes in the preferred mineral oils is less than 3 wt %, and the fraction of O, N and/or S-containing compounds is less than 6 wt %. The fraction of aromatic compounds and monomethyl-branched paraffins is in general in each case in the range of 0-40 wt %. In accordance with one interesting aspect, mineral oil comprises mainly naphthenic and paraffin-base alkanes, which in general have more than 13, preferably more than 18 and especially preferably more than 20 carbon atoms. The fraction of these compounds is in general at least 60 wt %, preferably at least 80 wt %, without any limitation intended by this. A preferred mineral oil contains 0.5-30 wt % aromatic components, 15-40 wt % naphthenic components, 35-80 wt % paraffin-base components, up to 3 wt % n-alkanes and 0.05-5 wt % polar components, in each case with respect to the total weight of the mineral oil.

An analysis of especially preferred mineral oils, which was done with traditional methods such as urea dewaxing and liquid chromatography on silica gel, shows, for example, the following components, where the percentages refer to the total weight of the relevant mineral oil:

n-alkanes with about 18-31 C atoms: 0.7-1.0%,

low-branched alkanes with 18-31 C atoms: 1.0-8.0%,

aromatic compounds with 14-32 C atoms: 0.4-10.7%,

iso- and cycloalkanes with 20-32 C atoms: 60.7-82.4%,

polar compounds: 0.1-0.8%,

loss: 6.9-19.4%.

Valuable advice regarding the analysis of mineral oil as well as a list of mineral oils that have other compositions can be found, for example, in Ullmann's Encyclopedia of Industrial Chemistry, 5th Edition on CDROM, 1997, under the entry “lubricants and related products.”

Preferably, the hydraulic fluid is based on mineral oil from API Group I, II, or III. According to a preferred embodiment of the present invention, a mineral oil containing at least 90% by weight saturates and at most about 0.03% sulfur measured by elemental analysis is used.

API Group IV and V synthetic oils are, among other substances, organic esters like carboxylic esters and phosphate esters; organic ethers like silicone oils and polyalkylene glycol; and synthetic hydrocarbons, especially polyolefins and Fischer-Tropsch (GTL) derived base oils. They are for the most part somewhat more expensive than the mineral oils, but they have advantages with regard to performance. For an explanation reference is made to the 5 API classes of base oil types (API: American Petroleum Institute).

American Petroleum Institute (API) Base Oil Classifications

| | | Sulfur (weight | Saturates |
|---|---|---|---|
| Base stock Group | Viscosity Index | %) | (weight %) |
| Group I | 80-120 | >0.03 | <90 |
| Group II | 80-120 | <0.03 | >90 |
| Group III | >120 | <0.03 | >90 |
| Group IV all synthetic | >120 | <0.03 | >99 |
| Polyalphaolefins (PAO) | | | |
| Group V all not | >120 | <0.03 | |
| included in Groups I-IV, | | | |
| e.g. esters, | | | |
| polyalkylene glycols | | | |

The Fischer-Tropsch derived base oil may be any Fischer-Tropsch derived base oil as disclosed in for example EP-A-776959, EP-A-668342, WO-A-9721788, WO-0015736 WO-0014188, WO-0014187, WO-0014183, WO-0014179, WO-0008115, WO-9941332, EP-1029029, WO-0118156 and WO-0157166. A thorough discussion of GTL technology can be found in: Henderson, H. E., “Gas to Liquids”, Chapter 19 of Synthetics, Mineral Oils, and Bio-Based Lubricants—Chemistry and Technology. Rudnick, L. R., (editor), CRC Press, Taylor and Francis, 2006, p. 317.

Synthetic hydrocarbons, include especially polyolefins. Especially polyalphaolefins (PAO) are preferred. These compounds are obtainable by polymerization of alkenes, especially alkenes having 3 to 12 carbon atoms, like propene, hexene-1, octene-1, and dodecene-1. Preferred PAOs have a number average molecular weight in the range of 200 to 10000 g/mol, more preferably 500 to 5000 g/mol.

Particularly, a polymeric viscosity index improver can be used as a component of the hydraulic fluid. Viscosity index improvers are e.g. disclosed in Ullmann's Encyclopedia of Industrial Chemistry, 5th Edition on CD-ROM, 1997.

Preferred polymers useful as VI improvers comprise units derived from alkyl esters having at least one ethylenically unsaturated group. Preferred polymers are obtainable by polymerizing, in particular, (meth)acrylates, maleates and fumarates. The term (meth)acrylates includes methacrylates and acrylates as well as mixtures of the two. The alkyl residue can be linear, cyclic or branched.

Mixtures to obtain preferred polymers comprising units derived from alkyl esters contain 0 to 100 wt %, preferably 0.5 to 90 wt %, especially 1 to 80 wt %, more preferably 1 to 30 wt %, more preferably 2 to 20 wt %, based on the total weight of the monomer mixture, of one or more ethylenically unsaturated ester compounds of formula (I)

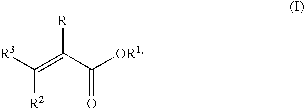

where R is hydrogen or methyl, R¹ means a linear or branched alkyl residue with 1-6, especially 1 to 5 and preferably 1 to 3 carbon atoms, R² and R³ are independently hydrogen or a group of the formula —COOR′, where R′ means hydrogen or an alkyl group with 1-6 carbon atoms. The amount of a compound of formula (I) in the mixture includes all values and subvalues therebetween, especially including 5, 10, 15, 20, 25, 30, 35, 40, 45, 50, 55, 60, 65, 70, 75, 80, 85, 90 and 95% by weight.

Examples of component (a) are, among others, (meth)acrylates, fumarates and maleates, which derived from saturated alcohols such as methyl(meth)acrylate, ethyl(meth)acrylate, n-propyl(meth)acrylate, isopropyl(meth)acrylate, n-butyl(meth)acrylate, tert-butyl(meth)acrylate, pentyl(meth)acrylate and hexyl(meth)acrylate; cycloalkyl(meth)acrylates, like cyclopentyl(meth)acrylate.

Furthermore, the monomer compositions to obtain the polymers comprising units derived from alkyl esters contain 0-100 wt %, preferably 10-99 wt %, especially 20-95 wt % and more preferably 30 to 85 wt %, based on the total weight of the monomer mixture, of one or more ethylenically unsaturated ester compounds of formula (II)

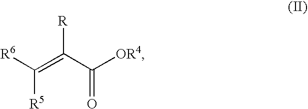

where R is hydrogen or methyl, R⁴ means a linear or branched alkyl residue with 7-40, especially 10 to 30 and preferably 12 to 24 carbon atoms, R⁵ and R⁶ are independently hydrogen or a group of the formula —COOR″, where R″ means hydrogen or an alkyl group with 7 to 40, especially 10 to 30 and preferably 12 to 24 carbon atoms. The amount of a compound of formula (II) in the mixture includes all values and subvalues therebetween, especially including 5, 10, 15, 20, 25, 30, 35, 40, 45, 50, 55, 60, 65, 70, 75, 80, 85, 90 and 95% by weight.

Among these are (meth)acrylates, fumarates and maleates that derive from saturated alcohols, such as 2-ethylhexyl(meth)acrylate, heptyl(meth)acrylate, 2-tert-butylheptyl(meth)acrylate, octyl(meth)acrylate, 3-isopropylheptyl(meth)acrylate, nonyl(meth)acrylate, decyl(meth)acrylate, undecyl(meth)acrylate, 5-methylundecyl(meth)acrylate, dodecyl(meth)acrylate, 2-methyldodecyl(meth)acrylate, tridecyl(meth)acrylate, 5-methyltridecyl(meth)acrylate, tetradecyl(meth)acrylate, pentadecyl(meth)acrylate, 2-methylhexadecyl(meth)acrylate, heptadecyl(meth)acrylate, 5-isopropylheptadecyl(meth)acrylate, 4-tert-butyloctadecyl(meth)acrylate, 5-ethyloctadecyl(meth)acrylate, 3-isopropyloctadecyl(meth)acrylate, octadecyl(meth)acrylate, nonadecyl(meth)acrylate, eicosyl(meth)acrylate, cetyleicosyl(meth)acrylate, stearyleicosyl(meth)acrylate, docosyl(meth)acrylate, and/or eicosyltetratriacontyl(meth)acrylate;

cycloalkyl(meth)acrylates such as 3-vinylcyclohexyl(meth)acrylate, cyclohexyl(meth)acrylate, bornyl(meth)acrylate, 2,4,5-tri-t-butyl-3-vinylcyclohexyl(meth)acrylate, 2,3,4,5-tetra-t-butylcyclohexyl(meth)acrylate; and the corresponding fumarates and maleates.

The ester compounds with a long-chain alcohol residue, especially component (b), can be obtained, for example, by reacting (meth)acrylates, fumarates, maleates and/or the corresponding acids with long chain fatty alcohols, where in general a mixture of esters such as (meth)acrylates with different long chain alcohol residues results. These fatty alcohols include, among others, Oxo Alcohol® 7911 and Oxo Alcohol® 7900, Oxo Alcohol® 1100 (Monsanto); Alphanol® 79 (ICI); Nafol® 1620, Alfol® 610 and Alfol® 810 (Sasol); Epal® 610 and Epal® 810 (Ethyl Corporation); Linevol® 79, Linevol® 911 and Dobanol® 25L (Shell AG); Lial 125 (Sasol); Dehydad® and Dehydad® and Lorol® (Cognis).

Of the ethylenically unsaturated ester compounds, the (meth)acrylates are particularly preferred over the maleates and furmarates, i.e., R², R³, R⁵, R⁶ of formulas (I) and (II) represent hydrogen in particularly preferred embodiments.

In a particular aspect of the present invention, preference is given to using mixtures of ethylenically unsaturated ester compounds of formula (II), and the mixtures have at least one (meth)acrylate having from 7 to 15 carbon atoms in the alcohol radical and at least one (meth)acrylate having from 16 to 30 carbon atoms in the alcohol radical. The fraction of the (meth)acrylates having from 7 to 15 carbon atoms in the alcohol radical is preferably in the range from 20 to 95% by weight, based on the weight of the monomer composition for the preparation of polymers. The fraction of the (meth)acrylates having from 16 to 30 carbon atoms in the alcohol radical is preferably in the range from 0.5 to 60% by weight based on the weight of the monomer composition for the preparation of the polymers comprising units derived from alkyl esters. The weight ratio of the (meth)acrylate having from 7 to 15 carbon atoms in the alcohol radical and the (meth) acrylate having from 16 to 30 carbon atoms in the alcohol radical is preferably in the range of 10:1 to 1:10, more preferably in the range of 5:1 to 1.5:1.

Component (c) comprises in particular ethylenically unsaturated monomers that can copolymerize with the ethylenically unsaturated ester compounds of formula (I) and/or (II).

Comonomers that correspond to the following formula are especially suitable for polymerization in accordance with the present invention:

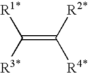

where R1* and R2* independently are selected from the group consisting of hydrogen, halogens, CN, linear or branched alkyl groups with 1-20, preferably 1-6 and especially preferably 1-4 carbon atoms, which can be substituted with 1 to (2n+1) halogen atoms, where n is the number of carbon atoms of the alkyl group (for example CF3), α,β-unsaturated linear or branched alkenyl or alkynyl groups with 2-10, preferably 2-6 and especially preferably 2-4 carbon atoms, which can be substituted with 1 to (2n−1) halogen atoms, preferably chlorine, where n is the number of carbon atoms of the alkyl group, for example CH2=CCl—, cycloalkyl groups with 3-8 carbon atoms, which can be substituted with 1 to (2n−1) halogen atoms, preferably chlorine, where n is the number of carbon atoms of the cycloalkyl group; C(═Y*)R5*, C(═Y*)NR⁶*R⁷*, Y*C(═Y*)R⁵*, SOR⁵*, SO₂R⁵*, OSO₂R⁵*, NR⁸*SO₂R⁵*, PR⁵*₂, P(═Y*)R⁵*₂, Y*PR⁵*₂, Y*P(═Y*)R⁵*₂, NR⁸*₂, which can be quaternized with an additional R⁸*, aryl, or heterocyclyl group, where Y* can be NR⁸*, S or O, preferably O; R⁵* is an alkyl group with 1-20 carbon atoms, an alkylthio group with 1-20 carbon atoms, OR¹⁵ (R¹⁵ is hydrogen or an alkali metal), alkoxy with 1-20 carbon atoms, aryloxy or heterocyclyloxy; R⁶* and R⁷* independently are hydrogen or an alkyl group with one to 20 carbon atoms, or R⁶* and R⁷* together can form an alkylene group with 2-7, preferably 2-5 carbon atoms, where they form a 3-8 member, preferably 3-6 member ring, and R⁸* is linear or branched alkyl or aryl groups with 1-20 carbon atoms;

R3* and R4* independently are chosen from the group consisting of hydrogen, halogen (preferably fluorine or chlorine), alkyl groups with 1-6 carbon atoms and COOR⁹*, where R⁹* is hydrogen, an alkali metal or an alkyl group with 1-40 carbon atoms, or R¹* and R³* can together form a group of the formula (CH₂)ₙ, which can be substituted with 1-2n′ halogen atoms or C₁-C₄ alkyl groups, or can form a group of the formula C(═O)—Y*—C(═O), where n′ is from 2-6, preferably 3 or 4, and Y* is defined as before; and where at least 2 of the residues R¹*, R²*, R³* and R⁴* are hydrogen or halogen.

The comonomers include, among others, hydroxyalkyl(meth)acrylates like 3-hydroxypropyl(meth)acrylate, 3,4-dihydroxybutyl(meth)acrylate, 2-hydroxyethyl(meth)acrylate, 2-hydroxypropyl(meth)acrylate, 2,5-dimethyl-1,6-hexanediol(meth)acrylate, 1,10-decanediol(meth)acrylate;

aminoalkyl(meth)acrylates and aminoalkyl(meth)acrylamides like N-(3-dimethylaminopropyl)methacrylamide, 3-diethylaminopentyl(meth)acrylate, 3-dibutylaminohexadecyl(meth)acrylate;

nitriles of (meth)acrylic acid and other nitrogen-containing (meth)acrylates like N-(methacryloyloxyethyl)diisobutylketimine, N-(methacryloyloxyethyl)dihexadecylketimine, (meth)acryloylamidoacetonitrile, 2-methacryloyloxyethylmethylcyanamide, cyanomethyl(meth)acrylate;

aryl(meth)acrylates like benzyl(meth)acrylate or phenyl(meth)acrylate, where the acryl residue in each case can be unsubstituted or substituted up to four times;

carbonyl-containing (meth)acrylates like 2-carboxyethyl(meth)acrylate, carboxymethyl(meth)acrylate, oxazolidinylethyl(meth)acrylate,

N-methyacryloyloxy)formamide, acetonyl(meth)acrylate, N-methacryloylmorpholine, N-methacryloyl-2-pyrrolidinone, N-(2-methyacryloxyoxyethyl)-2-pyrrolidinone, N-(3-methacryloyloxypropyl)-2-pyrrolidinone, N-(2-methyacryloyloxypentadecyl(-2-pyrrolidinone, N-(3-methacryloyloxyheptadecyl-2-pyrrolidinone;

(meth)acrylates of ether alcohols like tetrahydrofurfuryl(meth)acrylate, vinyloxyethoxyethyl(meth)acrylate, methoxyethoxyethyl(meth)acrylate, 1-butoxypropyl(meth)acrylate, 1-methyl-(2-vinyloxy)ethyl(meth)acrylate, cyclohexyloxymethyl(meth)acrylate, methoxymethoxyethyl(meth)acrylate, benzyloxymethyl(meth)acrylate, furfuryl(meth)acrylate, 2-butoxyethyl(meth)acrylate, 2-ethoxyethoxymethyl(meth)acrylate, 2-ethoxyethyl(meth)acrylate, ethoxylated(meth)acrylates, allyloxymethyl(meth)acrylate, 1-ethoxybutyl(meth)acrylate, methoxymethyl(meth)acrylate, 1-ethoxyethyl(meth)acrylate, ethoxymethyl(meth)acrylate;

(meth)acrylates of halogenated alcohols like 2,3-dibromopropyl(meth)acrylate, 4-bromophenyl(meth)acrylate, 1,3-dichloro-2-propyl(meth)acrylate, 2-bromoethyl(meth)acrylate, 2-iodoethyl(meth)acrylate, chloromethyl(meth)acrylate;

oxiranyl(meth)acrylate like 2,3-epoxybutyl(meth)acrylate, 3,4-epoxybutyl(meth)acrylate, 10,11 epoxyundecyl(meth)acrylate, 2,3-epoxycyclohexyl(meth)acrylate, oxiranyl(meth)acrylates such as 10,11-epoxyhexadecyl(meth)acrylate, glycidyl(meth)acrylate;

phosphorus-, boron- and/or silicon-containing (meth)acrylates like 2-(dimethylphosphato)propyl(meth)acrylate, 2-(ethylphosphito)propyl(meth)acrylate, 2-dimethylphosphinomethyl(meth)acrylate, dimethylphosphonoethyl(meth)acrylate, diethylmethacryloyl phosphonate, dipropylmethacryloyl phosphate, 2 (dibutylphosphono)ethyl(meth)acrylate, 2,3-butylenemethacryloylethyl borate, methyldiethoxymethacryloylethoxysiliane, diethylphosphatoethyl(meth)acrylate;

sulfur-containing (meth)acrylates like ethylsulfinylethyl(meth)acrylate, 4-thiocyanatobutyl(meth)acrylate, ethylsulfonylethyl(meth)acrylate, thiocyanatomethyl(meth)acrylate, methylsulfinylmethyl(meth)acrylate, bis(methacryloyloxyethyl)sulfide;

heterocyclic(meth)acrylates like 2-(1-imidazolyl)ethyl(meth)acrylate, 2-(4-morpholinyl)ethyl(meth)acrylate and 1-(2-methacryloyloxyethyl)-2-pyrrolidone;

vinyl halides such as, for example, vinyl chloride, vinyl fluoride, vinylidene chloride and vinylidene fluoride;

vinyl esters like vinyl acetate;

vinyl monomers containing aromatic groups like styrene, substituted styrenes with an alkyl substituent in the side chain, such as α-methylstyrene and α-ethylstyrene, substituted styrenes with an alkyl substituent on the ring such as vinyltoluene and p-methylstyrene, halogenated styrenes such as monochlorostyrenes, dichlorostyrenes, tribromostyrenes and tetrabromostyrenes;

heterocyclic vinyl compounds like 2-vinylpyridine, 3-vinylpyridine, 2-methyl-5-vinylpyridine, 3-ethyl-4-vinylpyridine, 2,3-dimethyl-5-vinylpyridine, vinylpyrimidine, vinylpiperidine, 9-vinylcarbazole, 3-vinylcarbazole, 4-vinylcarbazole, 1-vinylimidazole, 2-methyl-1-vinylimidazole, N-vinylpyrrolidone, 2-vinylpyrrolidone, N-vinylpyrrolidine, 3-vinylpyrrolidine, N-vinylcaprolactam, N-vinylbutyrolactam, vinyloxolane, vinylfuran, vinylthiophene, vinylthiolane, vinylthiazoles and hydrogenated vinylthiazoles, vinyloxazoles and hydrogenated vinyloxazoles;

vinyl and isoprenyl ethers;

maleic acid derivatives such as maleic anhydride, methylmaleic anhydride, maleinimide, methylmaleinimide;

fumaric acid and fumaric acid derivatives such as, for example, mono- and diesters of fumaric acid.

Monomers that have dispersing functionality can also be used as comonomers. These monomers contain usually hetero atoms such as oxygen and/or nitrogen. For example the previously mentioned hydroxyalkyl(meth)acrylates, aminoalkyl(meth)acrylates and aminoalkyl(meth)acrylamides, (meth)acrylates of ether alcohols, heterocyclic(meth)acrylates and heterocyclic vinyl compounds are considered as dispersing comononers.

Especially preferred mixtures contain methyl methacrylate, lauryl methacrylate and/or stearyl methacrylate.

The components can be used individually or as mixtures.

The hydraulic fluid of the present invention preferably comprises polyalkylmethacrylate polymers. These polymers are obtainable by polymerizing compositions comprising alkyl-methacrylate monomers. Preferably, these polyalkylmethacrylate polymers comprise at least 40% by weight, especially at least 50% by weight, more preferably at least 60% by weight and most preferably at least 80% by weight methacrylate repeating units. Preferably, these polyalkylmethacrylate polymers comprise C₉-C₂₄ methacrylate repeating units and C₁-C₈ methacrylate repeating units.

The molecular weight of the polymers derived from alkyl esters is not critical. Usually the polymers derived from alkyl esters have a molecular weight in the range of 300 to 1,000,000 g/mol, preferably in the range of range of 10000 to 200,000 g/mol and more preferably in the range of 25000 to 100,000 g/mol, without any limitation intended by this. These values refer to the weight average molecular weight of the polymers.

Without intending any limitation by this, the alkyl(meth)acrylate polymers exhibit a polydispersity, given by the ratio of the weight average molecular weight to the number average molecular weight Mw/Mn, in the range of 1 to 15, preferably 1.1 to 10, especially preferably 1.2 to 5. The polydispersity may be determined by gel permeation chromatography (GPC). The preferred polydipersity includes all values and subvalues therebetween, especially including 1.3, 1.4, 1.5, 1.6, 1.7, 1.8, 1.9, 2, 2.1, 2.5, 3, 3.5, 4 and 4.5.

The monomer mixtures described above can be polymerized by any known method. Conventional radical initiators can be used to perform a classic radical polymerization. Examples for these radical initiators are azo initiators like 2,2′-azodiisobutyronitrile (AIBN), 2,2′-azobis(2-methylbutyronitrile) and 1,1 azo-biscyclohexane carbonitrile; peroxide compounds, e.g. methyl ethyl ketone peroxide, acetyl acetone peroxide, dilauryl peroxide, tert.-butyl per-2-ethyl hexanoate, ketone peroxide, methyl isobutyl ketone peroxide, cyclohexanone peroxide, dibenzoyl peroxide, tert.-butyl perbenzoate, tert.-butyl peroxy isopropyl carbonate, 2,5-bis(2-ethylhexanoyl-peroxy)-2,5-dimethyl hexane, tert.-butyl peroxy 2-ethyl hexanoate, tert.-butyl peroxy-3,5,5-trimethyl hexanoate, dicumene peroxide, 1,1 bis(tert. butyl peroxy) cyclohexane, 1,1 bis(tert. butyl peroxy) 3,3,5-trimethyl cyclohexane, cumene hydroperoxide and tert.-butyl hydroperoxide.

Low weight average molecular weight poly(meth)acrylates can be obtained by using chain transfer agents. This technology is ubiquitously known and practiced in the polymer industry and is described in Odian, Principles of Polymerization, 1991. Examples of chain transfer agents are sulfur containing compounds such as thiols, e.g. n- and t-dodecanethiol, 2-mercaptoethanol, and mercapto carboxylic acid esters, e.g. methyl-3-mercaptopropionate. Preferred chain transfer agents contain up to 20, especially up to 15 and more preferably up to 12 carbon atoms. Furthermore, chain transfer agents may contain at least 1, especially at least 2 oxygen atoms.

Furthermore, the low weight average molecular weight poly(meth)acrylates can be obtained by using transition metal complexes, such as low spin cobalt complexes. These technologies are well known and for example described in USSR patent 940,487-A and by Heuts, et al., Macro-molecules 1999, pp 2511-2519 and 3907-3912.

Furthermore, polymerization techniques such as ATRP (Atom Transfer Radical Polymerization) and or RAFT (Reversible Addition Fragmentation Chain Transfer) can be applied to obtain useful polymers derived from alkyl esters. The ATRP reaction method is described, for example, by J-S. Wang, et al., J. Am. Chem. Soc., Vol. 117, pp. 5614-5615 (1995), and by Matyjaszewski, Macromolecules, Vol. 28, pp. 7901-7910 (1995). Moreover, the patent applications WO 96/30421, WO 97/47661, WO 97/18247, WO 98/40415 and WO 99/10387 disclose variations of the ATRP explained above to which reference is expressly made for purposes of the disclosure. The RAFT method is extensively presented in WO 98/01478, for example, to which reference is expressly made for purposes of the disclosure.

The polymerization can be carried out at normal pressure, reduced pressure or elevated pressure. The polymerization temperature is also not critical. However, in general it lies in the range of −20-200° C., preferably 0-130° C. and especially preferably 60-120° C., without any limitation intended by this.

The polymerization can be carried out with or without solvents. The term solvent is to be broadly understood here.

According to a preferred embodiment, the polymer is obtainable by a polymerization in API Group II or Group III mineral oil. These solvents are disclosed above.

Furthermore, polymers obtainable by polymerization in a polyalphaolefin (PAO) are preferred. More preferably, the PAO has a number average molecular weight in the range of 200 to 10000, more preferably 500 to 5000 g/mol. This solvent is disclosed above.

The hydraulic fluid may comprise 0.5 to 50% by weight, especially 1 to 30% by weight, and preferably 3 to 20% by weight, based on the total weight of the fluid, of one or more polymers derived from alkyl esters. According to a preferred embodiment of the present invention, the hydraulic fluid comprises at least 5% by weight of one or more polymers derived from alkyl esters. The amount of one or more polymers derived from alkyl esters includes all values and subvalues therebetween, especially including 5, 10, 15, 20, 25, 30, 35, 40 and 45% by weight.

According to a preferred aspect of the present invention, the fluid may comprise at least two polymers having a different monomer composition. Preferably at least one of the polymers is derived from alkyl esters. In another embodiment, at least one of the polymers is a polyolefin. A preferred combination is the use of a polymer derived from an alkyl ester, and a polymer derived from polyolefins. Preferably, the polyolefin is useful as a viscosity index improver.

These polyolefins include in particular polyolefin copolymers (OCP) and hydrogenated styrene/diene copolymers (HSD). The polyolefin copolymers (OCP) to be used according to the present invention are primarily polymers synthesized from ethylene, propylene, isoprene, butylene and/or further olefins having 5 to 20 carbon atoms. Systems which have been grafted with small amounts of oxygen- or nitrogen-containing monomers (e.g. from 0.05 to 5% by weight of maleic anhydride) may also be used. The copolymers which contain diene components are generally hydrogenated in order to reduce the oxidation sensitivity and the crosslinking tendency of the viscosity index improvers.

The weight average molecular weight Mw is in general from 10 000 to 300 000, preferably between 50 000 and 150 000. Such olefin copolymers are described, for example, in the German Laid-Open Applications DE-A 16 44 941, DE-A 17 69 834, DE-A 19 39 037, DE-A 19 63 039, and DEA 20 59 981.

Ethylene/propylene copolymers are particularly useful and terpolymers having ternary components, such as ethylidene-norbornene (cf. Macromolecular Reviews, Vol. 10 (1975)) are also possible, but their tendency to crosslink must also be taken into account in the aging process. The distribution may be substantially random, but sequential polymers comprising ethylene blocks can also advantageously be used. The ratio of the monomers ethylene/propylene is variable within certain limits, which can be set to about 75% for ethylene and about 80% for propylene as an upper limit. Owing to its reduced tendency to dissolve in oil, polypropylene is less suitable than ethylene/propylene copolymers. In addition to polymers having a predominantly atactic propylene incorporation, those having a more pronounced isotactic or syndiotactic propylene incorporation may also be used.

Such products are commercially available, for example under the trade names Dutral® CO 034, Dutralt CO 038, Dutral® CO 043, Dutral® CO 058, Buna® EPG 2050 or Buna® EPG 5050.

The hydrogenated styrene/diene copolymers (HSD) are being described, for example, in DE 21 56 122. They are in general hydrogenated isoprene/styrene or butadiene/styrene copolymers. The ratio of diene to styrene is preferably in the range from 2:1 to 1:2, particularly preferably about 55:45. The weight average molecular weight Mw is in general from 10000 to 300 000, preferably between 50000 and 150000 g/mol. According to a particular aspect of the present invention, the proportion of double bonds after the hydrogenation is not more than 15%, particularly preferably not more than 5%, based on the number of double bonds before the hydrogenation.

Hydrogenated styrene/diene copolymers can be commercially obtained under the trade name SHELLVIS® 50, 150, 200, 250 or 260.

Preferably, at least one of the polymers of the mixture comprises units derived from monomers selected from acrylate monomers, methacrylate monomers, fumarate monomers and/or maleate monomers. These polymers are described above.

The weight ratio of the polyolefin and the polymer comprises units derived from monomers selected from acrylate monomers, methacrylate monomers, fumarate monomers and/or maleate monomers may be in the range of 1:10 to 10:1, especially 1:5 to 5:1.

The hydraulic fluid may comprise usual additives. These additive include e.g. antioxidants, antiwear agents, corrosion inhibitors and/or defoamers, often purchased as a commercial additive package.

Preferably, the hydraulic fluid has a viscosity according to ASTM D 445 at 40° C. in the range of 10 to 150 mm²/s, more preferably 22 to 100 mm²/S.

Preferably, the hydraulic system includes the following components:
1. A unit creating mechanical energy, e.g. a combustion engine or an electrical motor.
2. A fluid flow or force-generating unit that converts mechanical energy into hydraulic power, such as a pump.
3. Piping for transmitting fluid under pressure.
4. A unit that converts the hydraulic power of the fluid into mechanical work or motion, such as an actuator or fluid motor. There are two types of motors, cylindrical and rotary.
5. A control circuit with valves that regulate flow, pressure, direction of movement, and applied forces.
6. A fluid reservoir that allows for separation of water, foam, entrained air, or debris before the clean fluid is returned to the system through a filter.
7. A fluid with low compressibility capable of operating without degradation under the conditions of the application (temperature, pressure, radiation).

Most complex systems will make use of multiple pumps, rotary motors, cylinders, electronically controlled with valves and regulators.

According to a preferred embodiment of the present invention, a vane pump or a piston pump can be used in order to create hydraulic power.

The system may be operated at high pressures. The improvement of the present invention can be achieved at pressures in the range of 50 to 700 bars, preferably 100 to 400 bars and more preferably 150 to 350 bars.

The unit creating mechanical energy, e.g. a motor can be operated at a speed of 500 to 5000 rpm, preferably 1000 to 3000 rpm and more preferably 1400 to 2000 rpm.

The hydraulic fluid can be used over a wide temperature window. Preferably, the fluid can be used at a temperature in the range of −30° C. to 200° C., more preferably 10° C. to 150° C., even more preferably 20-100° C., and most preferably 20-50° C. Usually, the operating temperature depends on the base fluid used to manufacture the hydraulic fluid.

Engine speed can be maintained at a constant level to deliver higher amounts of hydraulic power. Preferably, the mechanical power output of the engine or electrical motor can be operated at its full power capacity to deliver higher amounts of hydraulic power compared to the hydraulic system utilizing a standard HM grade fluid with a viscosity index less than 120.

Having generally described this invention, a further understanding can be obtained by reference to certain specific examples which are provided herein for purposes of illustration only, and are not intended to be limiting unless otherwise specified.

### EXAMPLES

A shear stable High VI (HVI) hydraulic fluid was compared to a standard non-VI Improved (HM) hydraulic fluid in a hydraulic dynamometer. The dynamometer was constructed for fluid testing in hydraulic motors. This dynamometer incorporates a pressure-compensated axial piston pump, a digital torque transducer, two 200 HP Powerflex 700S variable frequency drives (VFD) and an 18-channel Astro-Med Dash 18X data acquisition system that is capable of a 100 kHz sampling rate on each channel. The twin VFD controllers share a DC buss that enables electrical regeneration of the power absorbed by the load motor. One of the Powerflex 700S variable frequency drives (VFD) controls the motor for the hydraulic pump that delivers the test fluid to the hydraulic motor. The other VFD maintains the hydraulic motor speed at a constant 1 RPM and absorbs the load created in the process, returning electrical energy to the pump VFD. This reduces electrical energy and cooling water consumption.

Precise pressure, speed, torque and temperature control are required in order to accurately assess motor efficiency. Speed was controlled and monitored through the use of a 1000:1 constant-torque AC motor and a high resolution Heidenhain rotary encoder. Torque was measured in inch-pounds. Inlet and outlet temperatures (degrees F), inlet and outlet pressures (pounds per square inch) and fluid flow (gallons per minute) were also measured. Mechanical, Volumetric and Overall Efficiency were calculated as a per cent (%).

The following criteria are specified in International Standard ISO 4392-1, Hydraulic Fluid Power-Determination of Characteristics of Motors—Part 1: At constant low speed and constant pressure. Reference number ISO 4392-1:2002(E)
1) Connect the instrumentation and recording apparatus to record inlet and outlet pressure, temperature, output torque and total flow.
2) Maintain the measured inlet and outlet pressure constant to ±2% of the reading or 1 bar whichever is greater.
3) Maintain the output shaft speed within ±2% of the mean.
4) Maintain the measured inlet fluid temperature constant to ±2% degrees C. for the duration of a recording.
5) Establish thermal equilibrium before recording each set of test data. This may be achieved by operating the motor at rated speed while maintaining the inlet fluid temperature until outlet fluid temperature has stabilized,
6) Make separate simultaneous recordings of each of the variables listed in 1) for each combination of test values of differential pressure, inlet temperature, displacement and direction of rotation.
7) Extend the recording to as many revolutions as are necessary to achieve one complete motor cycle.
8) Record the actual measured values and test values of the corresponding parameters.
9) Make a note on the recordings of any tendency of the motor to operate in a jerky or non-uniform manner.
10) When using digital data acquisition techniques, select a sample interval which provides 95% confidence that the maximum and minimum values of leakage and torque have been determined by pretesting.
11) Make a note of any tendency of the motor to be non-repeatable in either torque or leakage.

Speed of the motor was held to one revolution per minute (RPM). Measurements were made at one hundredth (0.01) of a second (100 Hz) interval and recorded creating six thousand data points. Speed, temperature and pressure were maintained constant to insure validity of the test procedures. The same tests were run using different pressures ranging from 1000 psi to 4000 psi both in a clockwise (CW) and counterclockwise (CCW) direction. The tests were also run at three different temperatures, 50° C., 80° C. and 100° C., as well. Data was collected and recorded using an 18 channel Astro-Med Dash 18X data acquisition system and the Efficiencies were calculated.

### Example 1

TABLE 1
Description of test fluids

| | | | | Vis-Pressure |
|---|---|---|---|---|
| Sample | | Kin. Vis., | Viscosity | coefficient, |
| ID | Type | cSt at 40 C. | Index | αₒ @ 80 C. |
| HM | Solvent refined mineral oil with | 46 | 101 | 18.7 |
| | ashless antiwear additive | | | |
| HVI | Hydrocracked mineral oil + VII | 50 | 199 | 16.9 |
| | with ashless antiwear additive | | | |

SD 1 & 2 @ 80 C. with HM

| Ave P1 | SD1 | Ave P2 | SD2 | Nom. P | HM |
|---|---|---|---|---|---|
| 1021 | 53.3 | 1043 | 55.3 | 1000 | 54.3 |
| 1499 | 61.8 | 1470 | 63.2 | 1500 | 62.5 |
| 1979 | 67.0 | 1967 | 67.9 | 2000 | 67.5 |
| 2515 | 70.1 | 2467 | 70.8 | 2500 | 70.5 |
| 3010 | 72.4 | 2951 | 72.6 | 3000 | 72.5 |
| 3727 | 74.8 | 3881 | 75.5 | 4000 | 75.2 |

SD 1 & 2 @ 80 C. with HVI

| Ave P1 | SD1 | Ave P2 | SD2 | Nom. P | HVI | Improvement |
|---|---|---|---|---|---|---|
| 1003 | 63.0 | 990 | 64.2 | 1000 | 63.6 | 17.1 |
| 1509 | 71.9 | 1504 | 72.5 | 1500 | 72.2 | 15.5 |
| 1989 | 75.9 | 2012 | 76.7 | 2000 | 76.3 | 13.1 |
| 2496 | 78.9 | 2502 | 79.2 | 2500 | 79.1 | 12.2 |
| 2994 | 80.8 | 3015 | 81.1 | 3000 | 81.0 | 11.7 |
| 3936 | 83.1 | 3925 | 82.9 | 4000 | 83.0 | 10.4 |

Eaton 1 & 2 @ 80 C. with HM

| Ave Ea1 | Ea1 | Ave Ea2 | Ea2 | Nom. P | HM |
|---|---|---|---|---|---|
| 1021 | 56.9 | 1045 | 54.8 | 1000 | 55.9 |
| 1506 | 57.6 | 1495 | 56.7 | 1500 | 57.2 |
| 1980 | 58.2 | 1997 | 57.9 | 2000 | 58.1 |
| 2448 | 59.0 | 2457 | 57.9 | 2500 | 58.5 |
| 3020 | 58.9 | 2961 | 57.8 | 3000 | 58.4 |
| 3778 | 58.9 | 3776 | 58.4 | 4000 | 58.7 |

Eaton 1 & 2 @ 80 C. with HVI

| Ave Ea1 | Ea1 | Ave Ea2 | Ea2 | Nom. P | HVI | IMPROVEMENT | HVI |
|---|---|---|---|---|---|---|---|
| 1009 | 56.3 | 978 | 59.7 | 1000 | 58.0 | 3.8 | 58 |
| 1497 | 58.1 | 1492 | 61.2 | 1500 | 59.7 | 4.4 | 59.65 |
| 1970 | 59.1 | 1988 | 61.8 | 2000 | 60.5 | 4.1 | 60.45 |
| 2484 | 58.9 | 2473 | 61.9 | 2500 | 60.4 | 3.3 | 60.4 |
| 3003 | 59.3 | 2980 | 61.8 | 3000 | 60.6 | 3.8 | 60.55 |
| 3894 | 59.7 | 3840 | 61.5 | 4000 | 60.6 | 3.3 | 60.6 |

Graphs were then created from the spreadsheet to provide a visual method of analyzing the data.

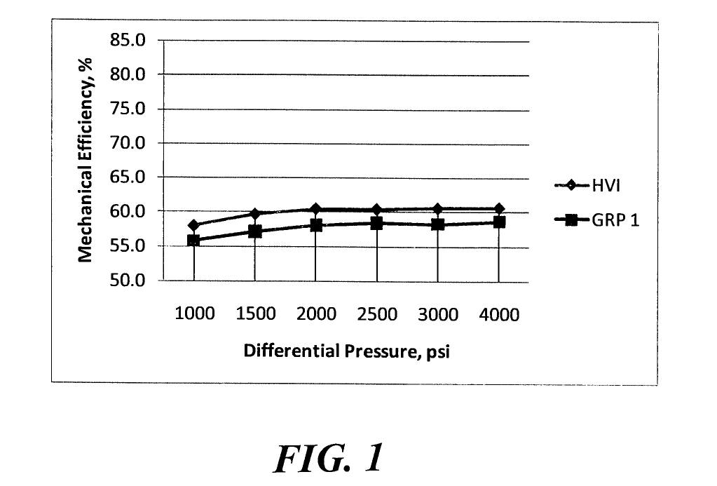

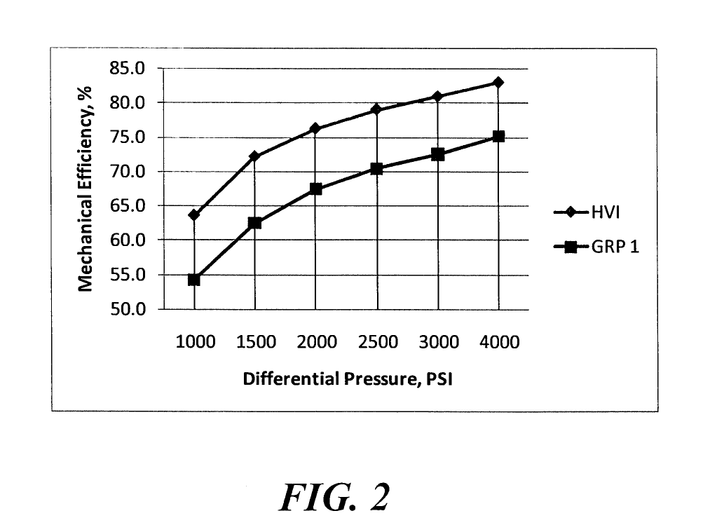

The HVI fluid increased the average torque efficiency from 58.7 to 60.6% in the geroler motor (FIG. 1) and 75.2 to 83.0% in the axial motor (FIG. 2) at 80C and 275 bar (4000 psi).

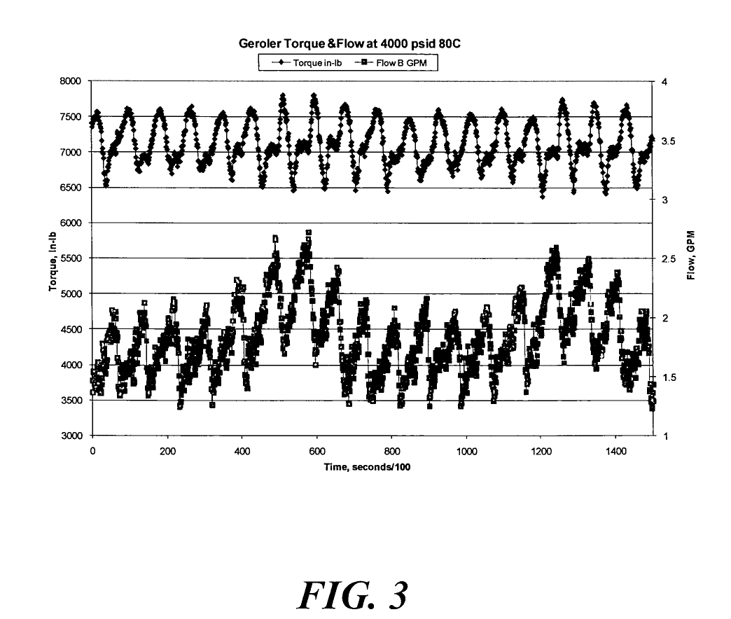

Evaluation at 15 second interval showed two complete cycles, (FIG. 3).

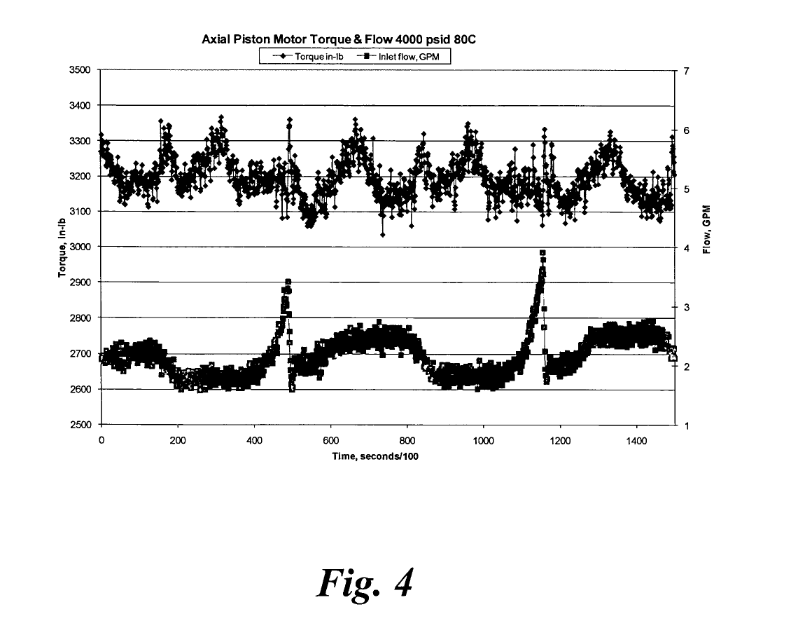

The torque ripple was identified and the highs and lows determined in order to calculate the increased torque efficiency. The analysis of the cyclic torque variation, (produced by the interaction of the 8 lobes and 9 valve plate ports in the geroler motor) revealed a periodicity of (N) (N+1) where N is the number of lobes in the geroler motor (FIG. 3). In the axial piston motor (FIG. 4) analysis of the cyclic torque variations revealed a periodicity of 4N where N equals the number pistons (9)

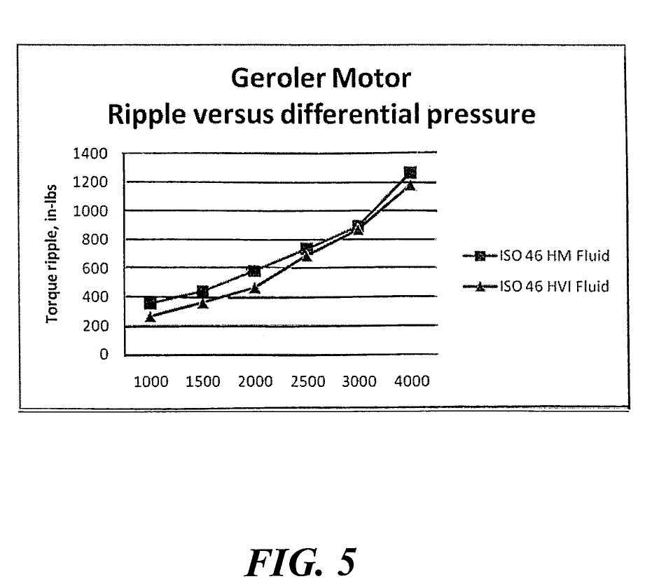

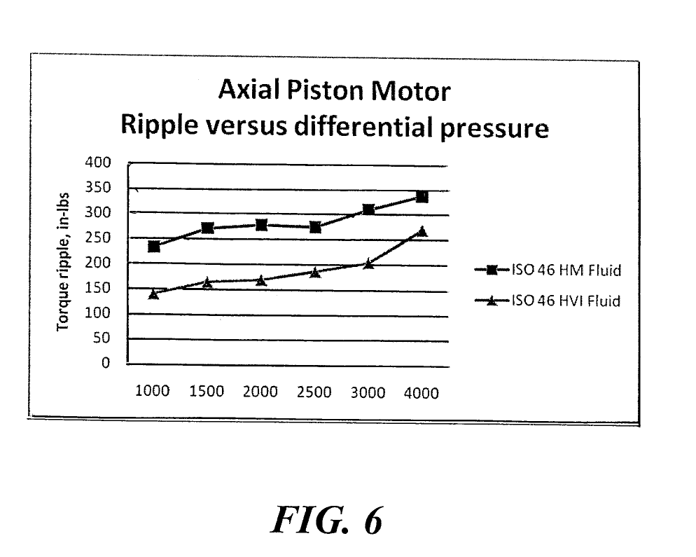

Spikes in leakage flow were found to produce a corresponding decrease in torque output. Reduced leakage flow in the motors is attributed to the higher viscosity index of the HVI fluid. In addition to increasing the average torque efficiency of motors, the shear stable HVI fluid was also found to reduce the amplitude of torque ripple (Table 2, FIGS. 5 and 6).

TABLE 2
Comparison of torque ripple

| | Geroler | | | |
|---|---|---|---|---|
| Differential | Torque Ripple, | | Axial Motor Torque | |
| Pressure | CW @ 80 C. | | Ripple, CW @ 80 C. | |
| (psi) | HM Fluid | HVI Fluid | HM Fluid | HVI Fluid |
| 1000 | 356.3 | 266.7 | 233.1 | 139.8 |
| 1500 | 437.8 | 360.6 | 270.8 | 163.6 |
| 2000 | 578.8 | 463.0 | 278.0 | 169.1 |
| 2500 | 733.2 | 686.9 | 274.9 | 186.1 |
| 3000 | 890.1 | 872.5 | 311.3 | 205.1 |
| 4000 | 1260.6 | 1180.1 | 338.0 | 270.7 |

Amplitude of torque ripple is defined as 2× the standard deviation of the ripple over one complete revolution at 1 RPM. As a result, the HVI fluid increased the average and minimum torque output of the geroler and axial piston motors. Increasing the minimum torque output is beneficial because it can reduce the size of motors required in fluid power applications where low speed torque dictates hydraulic system design pressure and motor displacement.

What is claimed as new and desired to be secured by Letters Patent of the United States is:

1. A method of reducing torque ripple in a hydraulic system, comprising: operating a hydraulic system with a hydraulic fluid having a VI of at least 130.

2. The method according to claim 1, wherein said reduction in torque ripple is at least 3% compared to the power output of a hydraulic system using a monograde hydraulic fluid having a VI of about 100, operating at the same pressure and temperature with identical mechanical power input from the engine or electric motor.

3. The method according to claim 1, wherein said reduction in torque ripple is at least 5% compared to the power output of a hydraulic system using a monograde hydraulic fluid having a VI of about 100, operating at the same pressure and temperature with identical mechanical power input from the engine or electric motor.

4. The method according to claim 1, wherein the pressure provided by a unit providing hydraulic power is in the range of 50 to 700 bar.

5. The method according to claim 1, wherein the pressure provided by a unit providing hydraulic power is in the range of 150 to 350 bar.

6. The method according to claims 1, wherein the hydraulic fluid has a VI of at least 150.

7. The method according to claim 1, wherein the hydraulic fluid has a VI of at least 180.

8. The method according to claim 1, wherein the hydraulic fluid is a NFPA double viscosity grade, triple viscosity grade, quadra viscosity grade, or penta viscosity grade hydraulic fluid.

9. The method according to claim 1, wherein the hydraulic fluid is obtained by mixing a base fluid and a polymeric viscosity index improver.

10. The method according to claim 1, wherein the hydraulic fluid comprises at least 60% by weight of at least one base fluid.

11. The method according to claim 1, wherein the hydraulic fluid comprises at least 60% by weight of at least one base fluid having a viscosity index of 120 or less.
